(19) United States
(12) Patent Application Publication
(10) Pub. No.: US 2013/0212795 A1
(43) Pub. Date: Aug. 22, 2013

(54) Bidet Adjustable In Height With Heating System

(71) Applicant: Sante Mastrogregori, Canepina (IT)

(72) Inventor: Sante Mastrogregori, Canepina (IT)

(21) Appl. No.: 13/459,190

(22) Filed: Apr. 29, 2012

(30) Foreign Application Priority Data
Feb. 16, 2012 (IT) FI2012A000027

(51) Int. Cl. A61H 35/00

(52) U.S. Cl. 4/443

(57) ABSTRACT

The bidet has a manual mechanical lift system that guarantees to adjust in height according to the needs of the user. It has a tablet and interchangeable heated by passing hot water inside to ensure a sensation of heat according to the needs of the user

### CROSS REFERENCE TO RELATED APPLICATION

This application is a following of the U.S. Utility application filed under 35 U.S.C. 111(a) Ser. No. 13/459,190 confirmation n. 8492 dated Apr. 29, 2012, revised according to the formalities letters no. OC000000054380549 dated May 21, 2012 and no. OC000000055719493 dated Aug. 2, 2012 of NOTICE TO FILE MISSING PARTS OF NONPROVISIONAL APPLICATION filed under 35 CFR 1.53 (b), Filing Date Granted;

It claims the Italian Industrial Patent application n. “FI2012A000027 dated Feb. 16, 2012 sent to the U.I.B.M. (Ufficio Italiano Brevet e Marchi), address: Via Molise 19, 00187 Roma, Italy, filed to the Chamber of commerce of Florence, ITALY.

### BACKGROUND OF THE INVENTION

The bidet become an object of daily use for all people and for this reason that the evolution of this product is become an indispensable factor for the welfare of the people who are increasingly demanding and require increasingly personalized and innovative products.

The “bidet adjustable in height with heating system” is an object useful for everyday needs, it is also not difficult to construct for the industries because it is similar to a normal bidet and it is not an object by the functionally complex although if it has different characteristics from standard bidet, and for this reason that this object could be manufactured in large scale; it will be construct to ensure that any person of any class may have the opportunity to buy at a reasonable price, an object innovative and functional.

### SUMMARY OF THE INVENTION

The bidet adjustable in height with heating system is a bidet very similar to a normal bidet in market but its features make it unique, in fact, while in past its facilities/comforts was dedicated mainly to people with physical problems now this innovations are dedicated to every kind of person.

This object has several innovation and the main are the following:

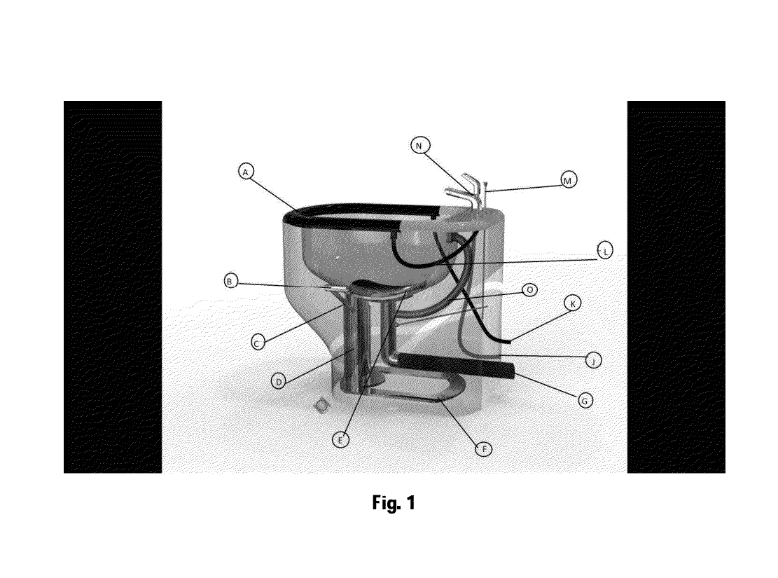

An “HIDRAULIC LIFT SYSTEM” (see FIG. 1 let. B+C+D) that allows to the bidet to rise and lower of 20 cm respect to the normal position, giving a greater seating comfort to taller or short people.

An “HEATED AND INTERCHANGEABLE TABLET” (see FIG. 1 let. A) realizable in various materials, to ensure that during the coldest periods user has not the feeling of cold that he can have with a normal bidet in ceramic material.

In fact it can be used by any type of person as a convenience to everyday life and for which it can be adapt to the daily needs of each person.

### BRIEF DESCRIPTION OF DRAWINGS

Below are described the main features of the patent in question, with reference to each drawing attached to this application.

Figure n. 1, show all the parts that make up the bidet, from the heated tablet with the letter A to its inlet and outlet pipes of hot water, letters L+K, to the “lift system” with letters B+C+D; while with the letter B is seen the lever to adjust the lift of the bidet; with the letter C is seen the rod/connecting rod with the piston hydraulic lift; with the letter D is seen the piston of lift which is very similar to that an office armchair.

In addition to this, it can be seen the recovery pipe water too, letter O; the two plates between the “top” and “bottom” of the bidet with the letter E+F, which form a single body with the piston; the drain hose, letter G; the pull for the water too, letter M; the mixer/faucet, letter N and all the other constituent parts of the bidet as the body that it seen in transparent.

Figure n. 2, show the outside of the bidet finished without the connecting pipes and in particular is seen, the heated and interchangeable tablet, letter O and that in this case is made of plastic material/composite.

In addition to this it can be seen the two holes with the letter W, where are connected tubes of “inlet” and “outlet” of hot water; the slot with the letter P, where is bonded the “tablet” interchangeably; the upper part and the lower part, with the letters R+S, which is the biggest part of the object; the “stainless steel plate” with the letter T, which is a guide for the lifting between the upper and lower parts of the bidet; the lift lever of the bidet, with the letter U and the outlet of the water too with letter Q; above it can be seen the faucet /mixer, while other external parts are described in the other figures.

Figure no. 3, show the upper part of the bidet with a view from above, noting mainly the “tablet heated ” (of black color) and the pipes connecting to it; the inlet tube of the cold water that goes directly into the mixer (of lighter color), the complete exhaust system, the mixer and the remaining of the upper part of the bidet.

In the figure n. 4 as shown in figure number 3, it can be noted the shape of the bidet and the housing of the tablet heated and interchangeable.

Figure n. 5, show the internal section of the bidet, specifically the “lift system” which forms a single body with the two support plates which connect the top and bottom of the bidet.

In Figure n. 6 as in figure n. 5, can be noted the lift system, seen from another angle of view and shows the robustness of a system that can withstand very high weights.

In Figure n. 7 can be noted in addition to the compactness of the bidet; the tubes of entry of hot water, in black (the smaller), the entry of cold water, in gray color (the smaller) and exhaust, in black color (the largest); all of them at the bottom of the bidet.

In Figure n. 8, as in figure n. 3, it can be seen the upper part of the bidet, in particular the interior of the bowl of the bidet, which has a shape quite common that is very similar to a standard bidet.

In Figure n. 9, as in figure n. 7, it can be noted the tablet heated, which is of a different color unlike the figure n. 7; can also seen, with reference to FIGS. n. 2 and n. 4 that is possible to insert different types of tablets, always of the same shape, but of different materials, depending of user's needs; in this case the tablet in the figure is made of plastic material/composite and chromium, in tone with the plate in stainless steel (lift guide) as it can be seen in the figure n. 2, letter T.

### DETAILED DESCRIPTION OF THE INVENTION

The bidet is composed mainly of three parts:

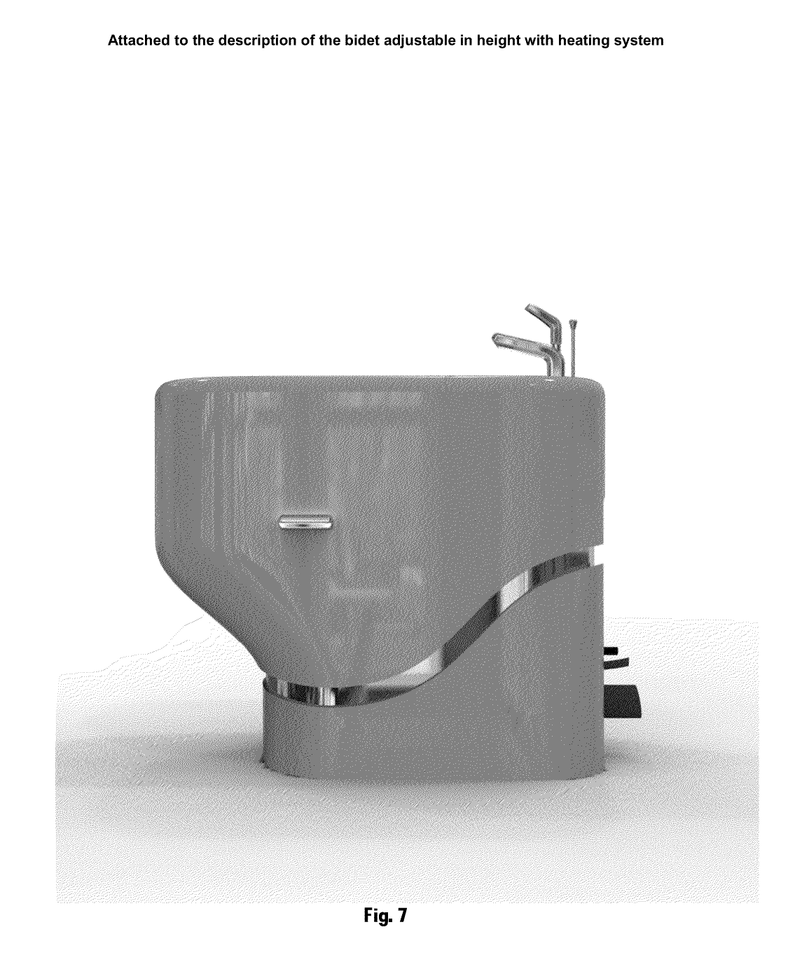

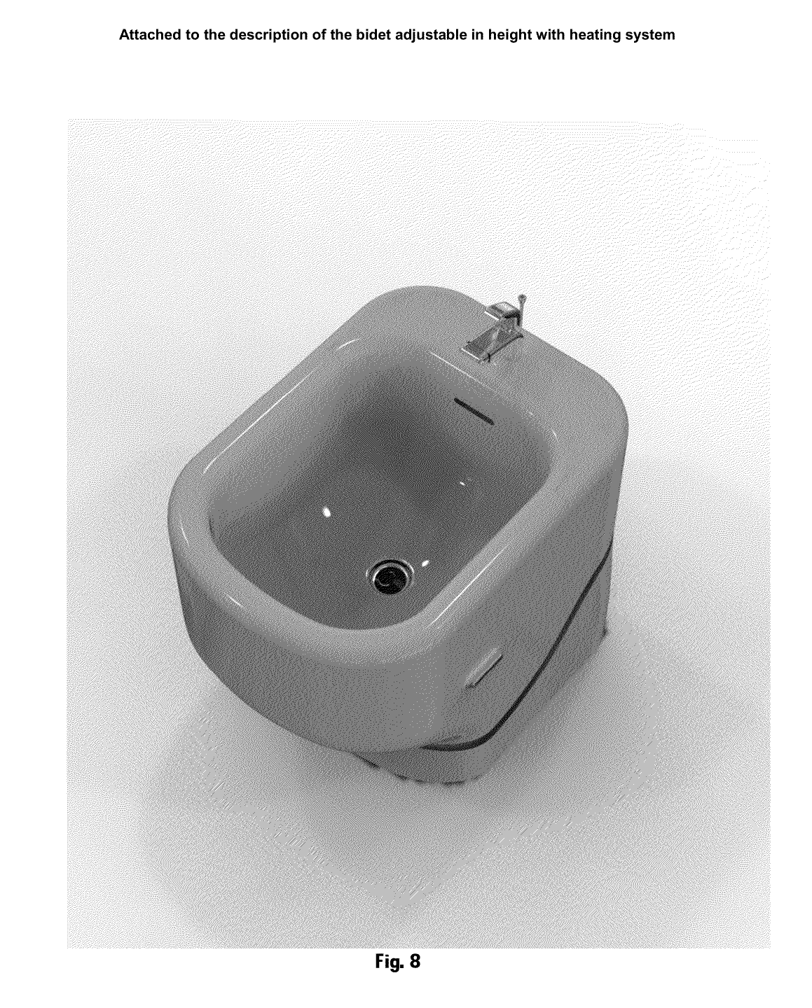

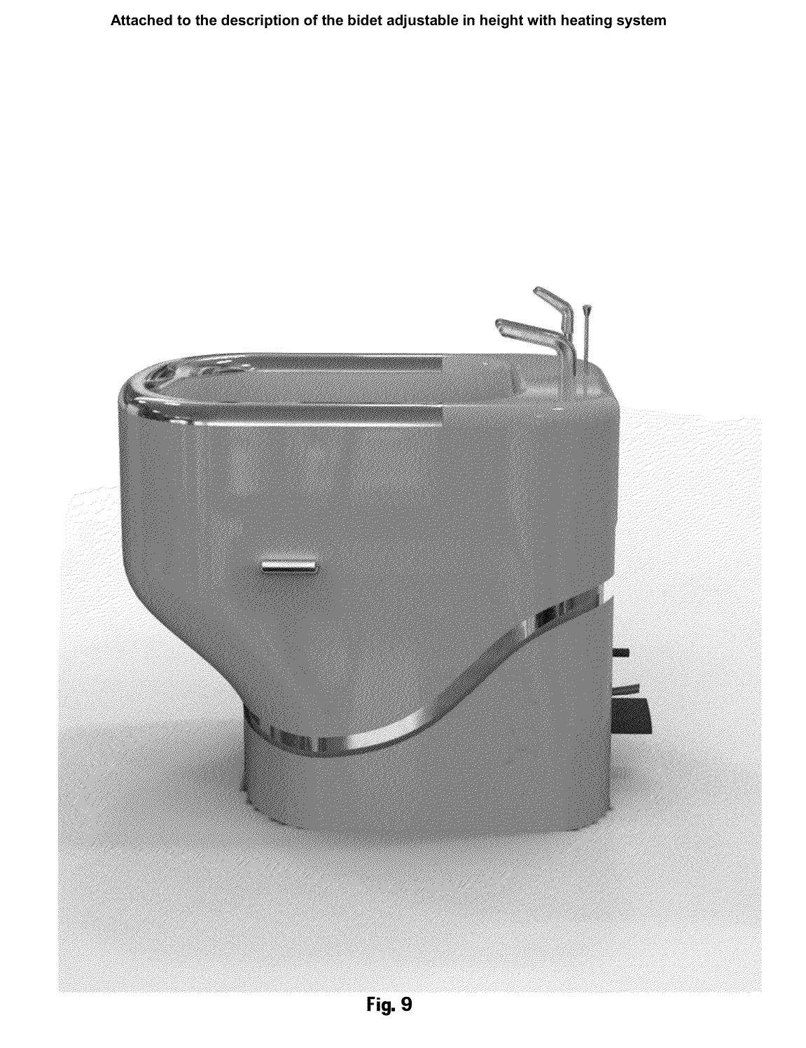

1) “BODY” (FIG. 7), it is the largest portion of the bidet, simple but compact which is divided into two parts:

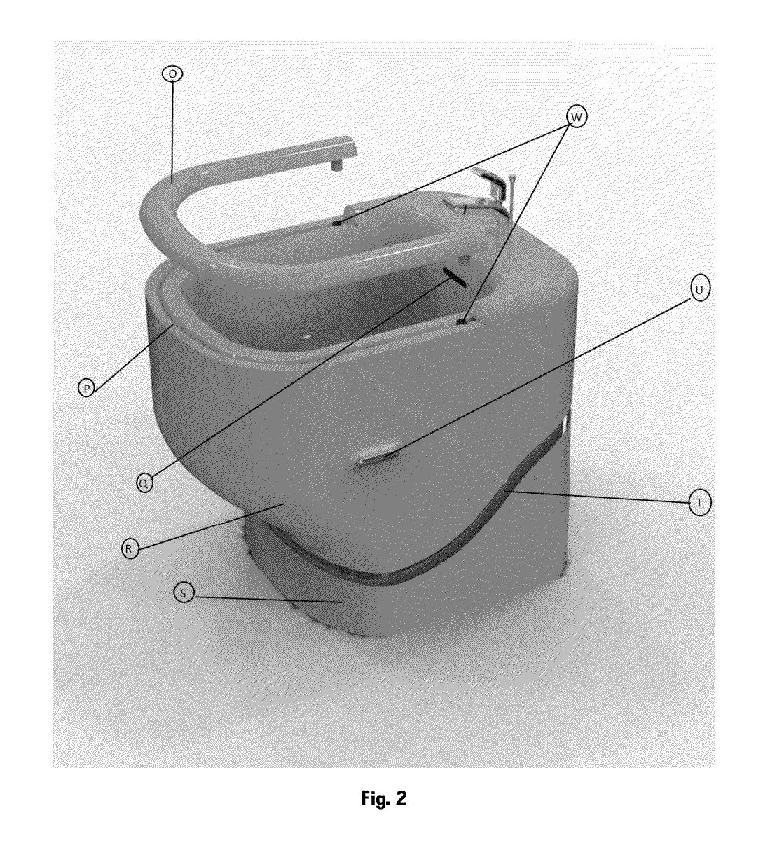

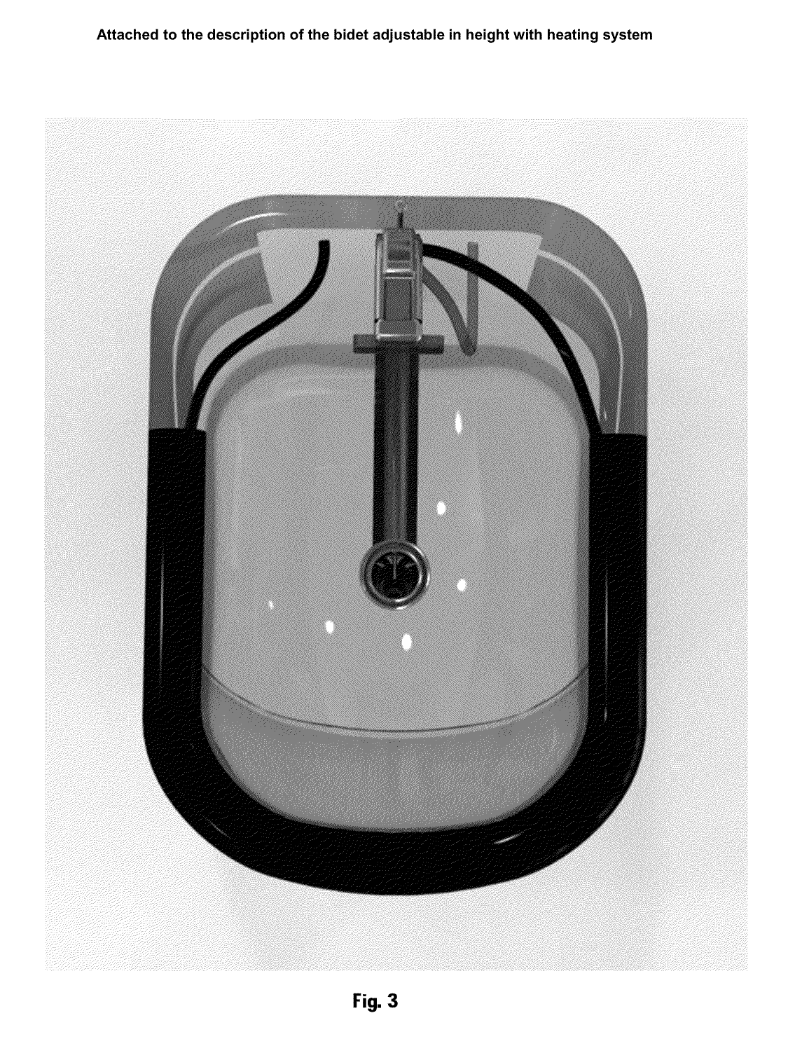

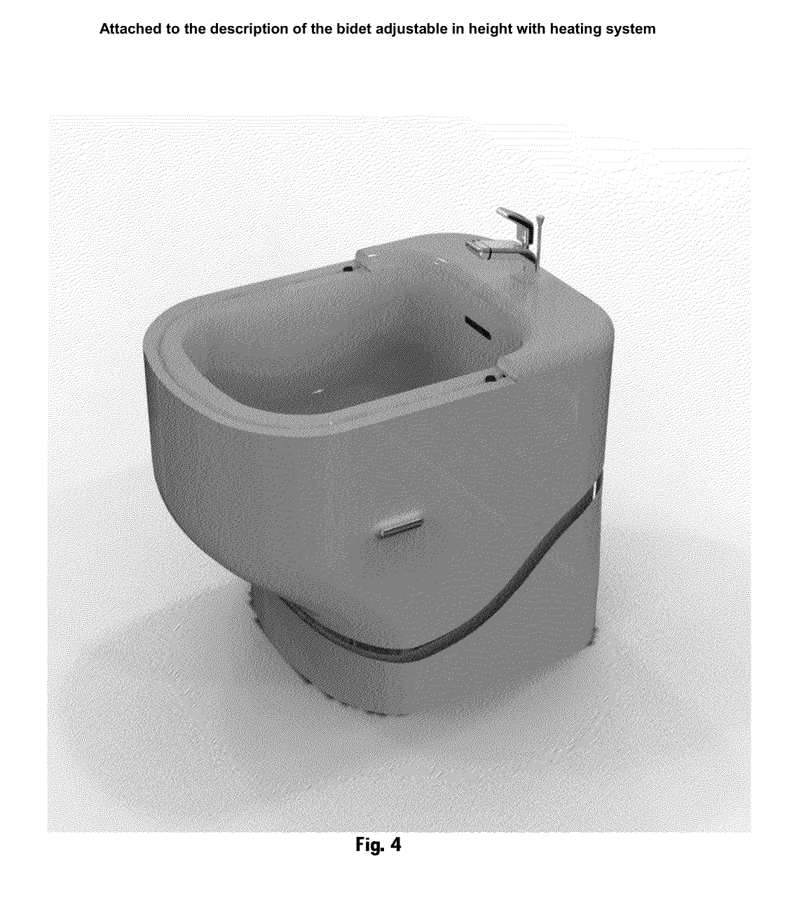

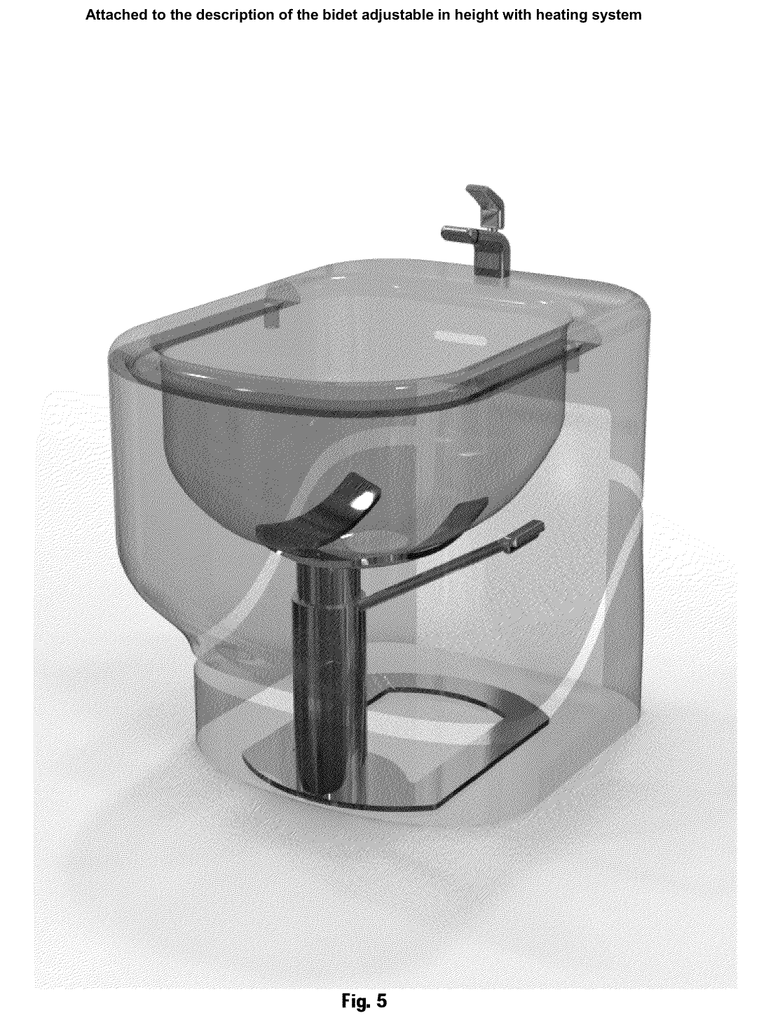

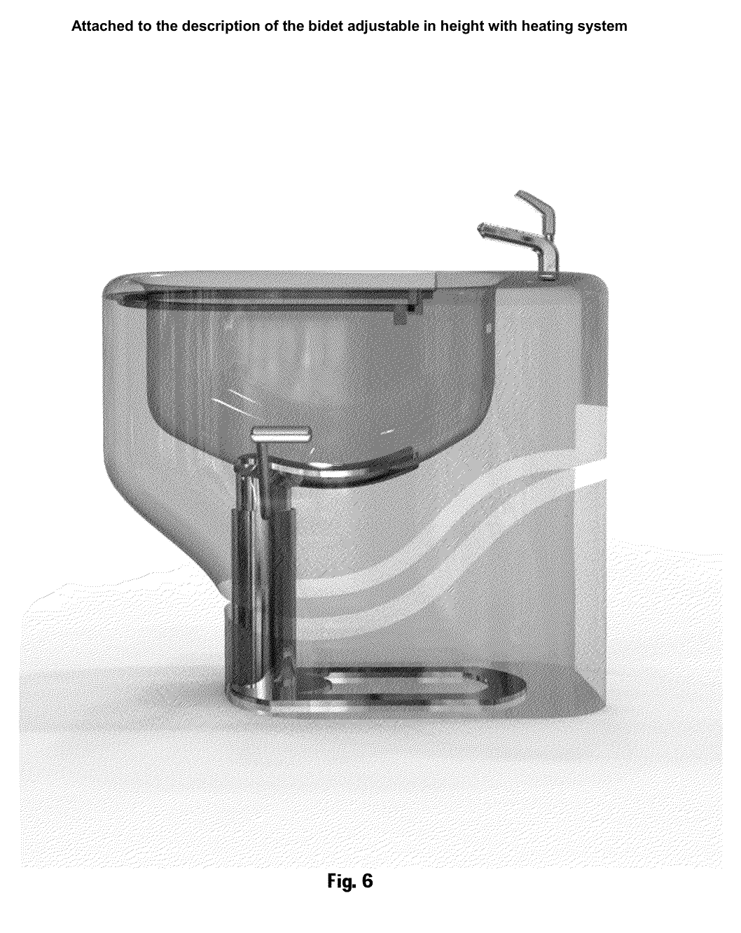

UPPER and LOWER (FIG. 2 let. R+S), which form the bidet itself, but separated to allow the lift system (FIG. 1 let. B+C+D described in later section) to do their function. At the LOWER part (FIG. 2 let S) is applied an interior PLATE OF STAINLESS STELL (FIG. 2 let. T) that it has also function of guide for the lift, while in the UPPER part there is a SLOT (FIG. 2 let. P) for housing the TABLET (FIG. 2 let. P described in later sections) and two HOLES (FIG. 2 let. W) for the inlet and outlet of CONNECTING PIPES (FIG. 1 let. L+K), necessary for heating the tablet.

2) “SYSTEM OF LIFT” (FIG. 1 let. B+C+D): Characterized by an HYDRAULIC PISTON system (FIG. 1 let. D) with a range in height of 20 cm, which is connected to the UPPER part (FIG. 2 let. R) and LOWER part (FIG. 1 let. D) that it does raise and lowered the bidet from 40 cm in the lowest position to 60 cm with the maximum excursion in height or vice versa, it depend to the needs of the user; when pulling the LEVER (FIG. 2 let. U) on the top the bidet rises, stopping at the moment user leave the lever to have desired height, while when user pull the LEVER on the top but he rests with the weight of his body on the bidet, it is lowered slowly to stop the desired height at the time when he leave the lever.

3) “TABLET HEATED” (FIG. 2 let. O): it can be produced in different materials, from the composite plastic to copper, stainless steel, which materials may be covered with other materials, to ensure that the bidet will be as possible near customers' request.

The tablet is composed in this way:

A) From the BODY OF THE TABLET (FIG. 2 let. O) which can vary in thickness depending on the type of material that is used, which is entirely empty inside to allow that when user open the mixer (FIG. 1 let. N), hot water enter and it does heating this part.

The “TABLET” in the underlying part has a projection that allows a perfect bonding with the “BODY” of the bidet (FIG. 2 let. P).

B) From 2 PIPES, inlet and outlet of water (FIG. 1 let. L+K), which are connected: the first, input pipe (FIG. 1 let. K) to the pipeline of “hot water” coming from boiler or other heater and then go to connect with the connection of inlet of tablet (FIG. 1 let. A), while the second, at the outlet of the tablet with outlet pipe (FIG. 1 let. L), then reconnect to the faucet/mixer itself (FIG. 1 let. N).

This description is relative to the main parts of the bidet, it describes the innovations of this object but we must consider also the rest of the components which are formed by connecting tubes of inlet of cold water (FIG. 1 let. J), of outlet, exhaust and water recovery, they are all hoses and couplings of common use ant with which it is possible to adapt the same bidet to any type of installation.

For this reason was not made a detailed description of the components themselves.

1) “Bidet adjustable in height with heating system” is characterized by a “LIFT SYSTEM” (FIG. 1 let B+C+D) which is composed by an HYDRAULIC PISTON (FIG. 1 let. D) with a range of 20 cm in height, from a LIFT LEVER (FIG. 1 let. B) which is connected to a piston by an stainless steel rod (FIG. 1 let. C) and from tow STAINLESS STEEL PLATES (upper and lower, FIG. 1 let. E+F) product in the same material of piston which forms a unique body with the piston because welded together.

2) “Bidet adjustable in height with heating system”, with reference to claim n. 1, is characterized by two main parts, the “UPPER” and the “LOWER” (FIG. 2 let. R+S) which allows to the bidet of lift up of 20 cm compared to a normal position.

3) “Bidet adjustable in height with heating system” with reference to claims n. 1 and n. 2, it has in the upper part (FIG. 2 let. R) a projection (FIG. 2 let. P) for insert the “HEATING TABLET” (FIG. 2 let. O), interchangeable, realizable in various materials (plastic, plastic/ceramic, copper, stainless steel etc.) that it can be recovered by other materials as paints, ceramic paints, chrome, or gold and silver effect, it depend of needs costumers.

4) “Bidet adjustable in height with heating system”, with reference to claim n. 2, in the upper part (FIG. 2 let. R) it has an “HOLE OF RECOVERY WATER TOO” (FIG. 2 let. Q) that has a cutting more large than normal to facility water in exit.

5) “Bidet adjustable in height with heating system” with reference to claims n. 2 and n. 4, in the internal part it has a “TUBE OF RECOVERY WATER TOO” (FIG. 1 let. O) that is separated compared to the other bidet that forms a unique part with the body of the bidet.

6) “Bidet adjustable in height with heating system”, with reference to claim n. 2, in the upper part (FIG. 2 let. R) it has a MIXER for the water (FIG. 1 let. N) of rectangular form that is attached to the opening/regulator lever of water only from a thin part of metal and it forms a single body compared to other mix.

7) “Bidet adjustable in height with heating system” with reference to the claims n. 2, n. 4, n. 5 and. n. 6, it has a “CLOSURE SYSTEM OF DESHARGE” of water (FIG. 1 let. M) that is insert directly in the body of the bidet from special hole.

8) “Bidet adjustable in height with heating system”, with reference to the claims n. 1, n. 2 and n. 3, in the upper part (FIG. 2 let. R) it has a “LEVER OF LIFT” (FIG. 1 let. B or FIG. 2 let. U) realizable in different materials as composite, chrome, silver, gold metal etc.
